(19) United States
(12) Patent Application Publication
(10) Pub. No.: US 2006/0262057 A1
(43) Pub. Date: Nov. 23, 2006

(54) Display device with switchable viewing angle, and terminal device

(75) Inventor: Ken Sumiyoshi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/434,829

(22) Filed: May 17, 2006

(30) Foreign Application Priority Data
May 17, 2005 (JP) 2005-144746

(51) Int. Cl. G09G 3/36

(52) U.S. Cl. 345/87

(57) ABSTRACT

Arranged in sequence in a display device are a planar light source, a viewing-angle control unit for increasing the directivity of transmitted light, a switching element for switching between a transparent state for transmitting incident light without modification and a translucent clouded state for transmitting the incident light in scattered fashion, and a display panel. The frequency F2 of the alternating current voltage applied to the switching element by the drive unit is made higher than the drive frequency F1 of the display panel. For example, the frequency F2 is twice the frequency F1 or higher, and is an n^{th} multiple (wherein n is an integer equal to 2 or higher) of the frequency F1. A display device with a switchable viewing angle is thereby obtained in which flickering does not occur even when the display device is used for a long time, and a terminal device is obtained in which the display device is mounted.

### BACKGROUND OF THE INVENTION

1. Field of the Invention

The present invention relates to a display device with a switchable viewing angle in which the viewable angle can be switched, and to a terminal device equipped with the same.

2. Description of the Related Art

There has been a recent demand for security features in display devices. For example, security codes and other confidential information must be entered when an ATM (Automated Teller Machine) or other financial terminal is operated, and the user must avoid allowing this information to be recognized by others. A feature is also desired in a mobile telephone or the like that prevents incoming mail and other image information from being seen by others. The same feature is also desired in PDAs (Personal Digital Assistance: personal information terminal), notebook-type personal computers, and other mobile terminal devices when these devices are used in trains and other public transportation institutions.

On the other hand, there is also a demand for enabling these display devices to be visible to multiple users at once. Viewing television on a mobile telephone is one example of this feature. The data screen of a notebook-type personal computer is also sometimes viewed by multiple users at once.

A display device with a switchable viewing angle that is provided with the capability of switching the viewing angle has been developed as a way to provide this type of reversible display functionality. By controlling the viewing angle in this display device, it is possible to switch between a narrow-angle mode for viewing highly confidential information in personal fashion and a wide-angle mode for viewing highly public information with a plurality of people.

This type of display device with a switchable viewing angle is proposed in Japanese Laid-Open Patent Application 9-197405. FIG. 1 is a side view showing the display device according to Japanese Laid-Open Patent Application 9-197405. As shown in FIG. 1, arranged in sequence in this conventional display device are a light source 101, a first optical element 102 for increasing the directivity of the light emitted from this light source 101, a second optical element 103 for switching between a state for transmitting the light incident from the first optical element 102 without modification and a state for scattering the light, and a transmissive liquid crystal display panel 104 for displaying an image by transmitting the light emitted from the second optical element 103. The first optical element 102 is a linear louver film, for example. The second optical element 103 switches according to an applied voltage between a transparent state in which the incident light is transmitted without modification and a clouded state in which the incident light is scattered. Examples of specific elements for performing this function include polymer-dispersed liquid crystal, polymer network liquid crystal, capsule-type liquid crystal, and other scattering-type liquid crystal elements.

The operational principle of this display device will next be described. In the narrow-angle mode, the second optical element is in the transparent state. Therefore, the directivity of the light emitted from the light source 101 is increased by the first optical element 102, the light passes through the second optical element 103 while still in a state of high directivity, and enters the display panel 104. An image is formed in the display panel 104 by a plurality of pixels, and the incident light passes through the display panel 104, whereby the image is displayed. However, the directivity of the incident light is not significantly affected by this process. Therefore, since the light having an associated image reaches an observer positioned in the direction (hereinafter referred to as “in front of the display device”) perpendicular to the screen, this observer can see the displayed image. However, the light having an associated image does not reach an observer who is in a position (hereinafter referred to as a diagonal position) other than in front of the display device, and this observer cannot see the displayed image.

In the wide-angle mode, the second optical element is in the scattering state. Therefore, the light whose directivity is increased by the first optical element is reduced in directivity and scattered by the second optical element. This scattered light is incident on the display panel and is emitted in a wide range of angles from the display panel. Therefore, not only is the image visible to an observer in front of the display device, but is also visible to an observer in a diagonal position.

Another display device with a switchable viewing angle is proposed in Japanese Laid-Open Patent Application 6-59287. FIG. 2 is a side view of the display device described in Japanese Laid-Open Patent Application 6-59287. As shown in FIG. 2, a light source 111, a guest-host liquid crystal element 112, and a display panel 113 are arranged in sequence in this conventional display device. The guest-host liquid crystal element 112 includes dichroic dye molecules having a slender shape. The display panel 113 is a transmissive liquid crystal display panel.

In this display device, diffused light is emitted from the light source 111 and is incident on the guest-host liquid crystal element 112. At this time, when the dichroic dye molecules in the guest-host liquid crystal element 112 are oriented substantially perpendicular to the substrate surface of the guest-host liquid crystal element 112, the light that is incident in the direction normal to the substrate surface is weakly absorbed, and the light that is incident in a direction that is tilted from the direction normal to the substrate surface is strongly absorbed. The light emitted from the light source 111 is therefore increased in directivity by passing through the guest-host liquid crystal element 112. The light emitted from the guest-host liquid crystal element 112 is then transmitted through the display panel 113 while still in a state of high directivity, and an image is associated with the light. Accordingly, only an observer in front of the display device can see the image, and an observer in a diagonal position cannot see the image. This condition corresponds to the narrow-angle mode.

When the dichroic dye molecules in the guest-host liquid crystal element 112 are oriented substantially parallel to the substrate surface, it becomes possible to display an image without any additional light loss if the orientation of the dichroic dye molecules in the plane of the substrate matches the orientation of the absorption axis of a polarizing plate (not shown in the drawing) disposed on the incident side of the display panel 113. Since the dichroic dye molecules are then oriented parallel to the substrate surface, there is no strong absorption of light that enters at an angle. Therefore, the image can be seen not only by an observer who is in front of the display device, but also by an observer in a diagonal position. This condition corresponds to the wide-angle mode.

As described above, any of the display devices disclosed in Japanese Laid-Open Patent Application Nos. 9-197405 and 6-59287 enable control of the viewing angle range, and enable narrow-angle/wide-angle switching.

However, the conventional techniques described above suffer from such problems as those described below. The scattering-type liquid crystal element and guest-host liquid crystal element described above usually include more ionic impurities than the liquid crystal used in the display panel. Ionic impurities are sometimes included in the liquid crystal from the time the display device is manufactured, or are sometimes introduced from the outside after the display device is manufactured. Such ionic impurities are easily caused to move to the vicinity of the boundary with the substrate by an applied electric field. As in the case of the liquid crystals of a common display panel, an electric field that alternates between positive and negative is also usually applied to the scattering-type liquid crystal element and guest-host liquid crystal element. The ionic impurities may therefore be thought not to move in the long term. However, a precise positive-negative alternating electric field that includes absolutely no direct-current component is extremely difficult to supply in actual practice. Accordingly, the ionic impurities eventually become unevenly distributed when the display device is used for a long period of time. When the ionic impurities are unevenly distributed in the liquid crystal, it becomes impossible to obtain a symmetrical optical response even when a positive-negative alternating electric field is applied. Thus, even when a sign-symmetrical optical response is obtained according to design specifications at the time the display device is manufactured, the optical response becomes asymmetrical over time, and flickering occurs.

In order to install a display device in a mobile terminal or the like, the display device must have a thin profile, and its mechanical durability must be increased. The substrate of the abovementioned scattering-type liquid crystal element or guest-host liquid crystal element is therefore preferably formed from a transparent resin (plastic, for example). However, since the moisture permeability of the substrate decreases compared to that of a glass substrate when the substrate is formed from plastic, ionic impurities are more easily introduced into the liquid crystal element. The problem of flickering caused by the uneven distribution of ionic impurities described above therefore becomes more severe.

### SUMMARY OF THE INVENTION

An object of the present invention is to provide a display device with a switchable viewing angle in which flickering does not occur even when the display device is used for a long period of time, and to provide a terminal device in which the display device is mounted.

The display device with a switchable viewing angle according to the present invention has a switching element that is capable of switching between scattering and directly transmitting incident light, a display panel for displaying an image by transmitting the light that is emitted from the switching element, and a drive unit for switching the switching element to the transmitting state or to the scattering state by switching on and off the application of an alternating current voltage to the switching element, wherein the frequency of the alternating current voltage applied by the drive unit to the switching element is higher than the drive frequency of the display panel.

In the present invention, by making the frequency of the alternating current voltage higher than the drive frequency of the display panel, the asymmetry of the optical response between when a positive potential is applied to the switching element and when a negative potential is applied becomes difficult for an observer to identify as flicker. The occurrence of flicker can thereby be suppressed.

The frequency of the alternating current voltage is preferably higher than 60 Hz. The occurrence of flicker can thereby be more reliably prevented.

Furthermore, the frequency of the alternating current voltage is twice the drive frequency of the display panel or higher. The variation frequency of the display image thereby becomes equal to or higher than the drive frequency of the display panel, and the occurrence of flicker can be more reliably prevented. The frequency of the alternating current voltage in this instance is preferably an n^{th} multiple (wherein n is an integer equal to 2 or higher) of the drive frequency of the display panel.

Furthermore, the switching element preferably has two substrates composed of transparent plastic, and a liquid crystal layer disposed between the substrates. The switching element can thereby be given a thinner profile, and the mechanical durability thereof can be increased.

The terminal device according to the present invention comprises the aforementioned display device with a switchable viewing angle.

According to the present invention, a display device with a switchable viewing angle can be obtained in which flicker does not occur even when the display device is used for a long period of time.

### BRIEF DESCRIPTION OF THE DRAWINGS

FIG. 1 is a side view of the display device described in Japanese Laid-Open Patent Application 9-197405;

FIG. 2 is a side view of the display device described in Japanese Laid-Open Patent Application 6-59287;

FIG. 3 is a schematic side view of the display device according to a first embodiment of the present invention;

FIG. 4 is a detailed sectional view of the display device according to the present embodiment;

FIG. 5 is a perspective view of the display device;

FIG. 6 is a sectional view of the display device according to a second embodiment of the present invention;

FIG. 7 is a side view of the display device according to a third embodiment of the present invention;

FIG. 8 is a side view of the display device according to a fourth embodiment of the present invention;

FIG. 9 is a side view of the display device according to a fifth embodiment of the present invention;

FIG. 10 is a sectional view of the display device according to a sixth embodiment of the present invention;

FIG. 11 is a sectional view of the display device according to a seventh embodiment of the present invention;

FIG. 12 is a sectional view of the display device according to an eighth embodiment of the present invention;

FIG. 13 is a sectional view of the display device according to a ninth embodiment of the present invention;

FIG. 14 is a side view of the display device according to a tenth embodiment of the present invention; and

FIG. 15 is a perspective view of the terminal device according to an eleventh embodiment of the present invention.

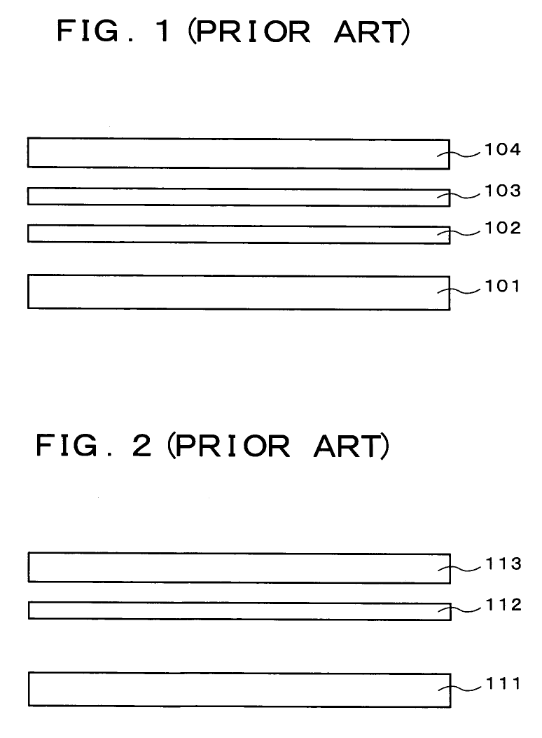

### DESCRIPTION OF THE PREFERRED EMBODIMENTS

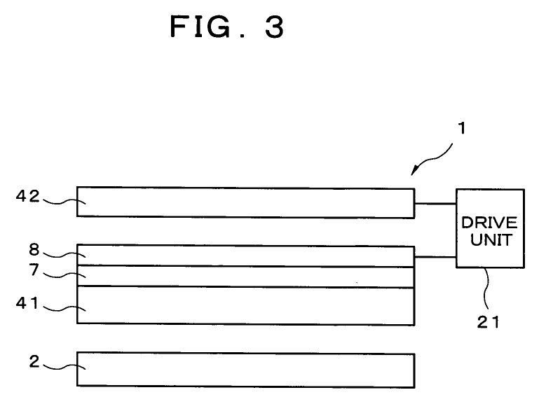

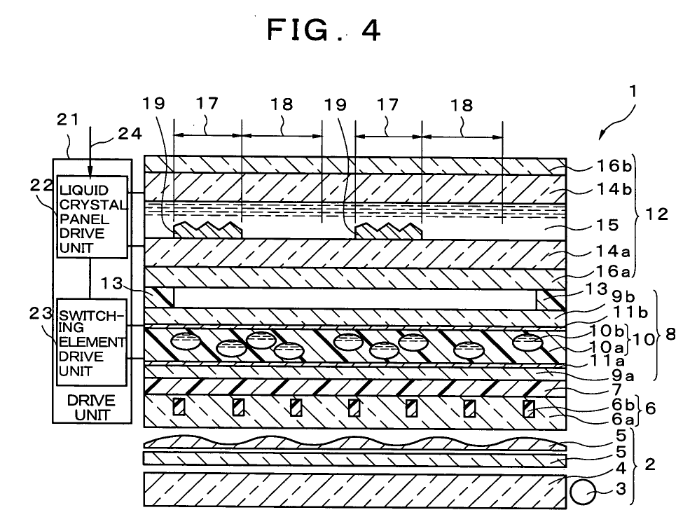

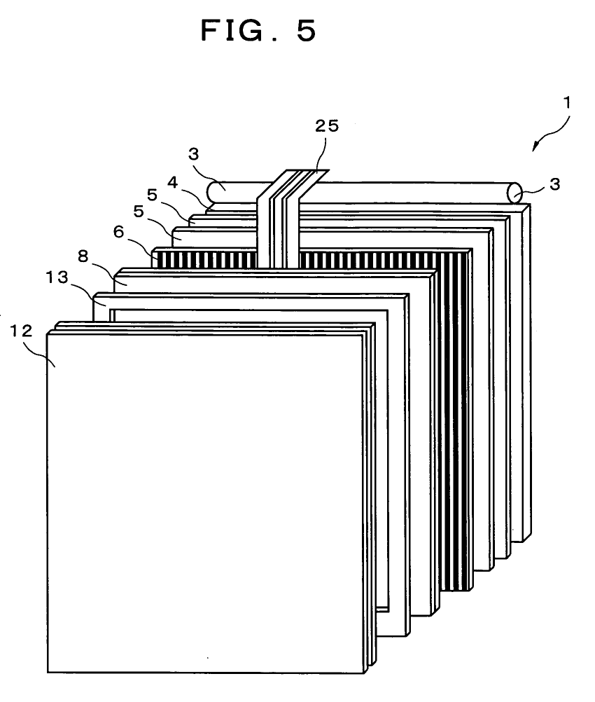

Embodiments of the present invention will be described in detail hereinafter with reference to the accompanying drawings. A first embodiment of the present invention will first be described. FIG. 3 is a schematic side view of the display device according to the present embodiment; FIG. 4 is a detailed sectional view of this display device; and FIG. 5 is a perspective view of this display device.

As shown in FIG. 3, in the display device 1 according to the present embodiment, a planar light source 2 is provided for emitting light in a plane towards the front of the display device 1, specifically, towards an observer, and a viewing-angle control unit 41 is provided for increasing the directivity of the transmitted light. A switching element 8 is bonded via an adhesive layer 7 to the front surface of the viewing-angle control unit 41. The switching element 8 switches between a transparent state for transmitting the incident light without modification and a translucent clouded state for transmitting the incident light in scattered fashion. Furthermore, a display panel 42 is provided to the front of the switching element 8. The display panel 42 is a transmissive or transflective display panel for associating an image with light by transmitting the light that is emitted from the switching element 8. A drive unit 21 for driving the switching element 8 and the display panel 42 is also provided to the display device 1.

The structure of the display device 1 will be described in further detail hereinafter. As shown in FIG. 4, a CCFL (Cold-Cathode Fluorescent Lamp), for example, or other cold cathode tube 3 is provided to the planar light source 2. The cold cathode tube 3 includes mercury vapor and emits visible light by excitation of phosphors by ultraviolet light generated from the mercury vapor. An optical waveguide 4 is also provided to the planar light source 2. The optical waveguide 4 is a plate-shaped member composed of transparent plastic, for example, and the normal to the principal surface thereof is in the frontal direction. The cold cathode tube 3 is disposed to the side of the optical waveguide 4 so that light is incident on the lateral surface of the optical waveguide 4. The light that is incident from the lateral surface is emitted by the optical waveguide 4 in planar fashion from the front surface (light-emitting surface) thereof. Furthermore, two prism sheets 5 are provided to the front of the optical waveguide 4. The prism sheets 5 cause the light emitted from the optical waveguide 4 to be propagated primarily in the forward direction. The cold cathode tube 3, optical waveguide 4, and prism sheets 5 constitute the planar light source 2.

A linear louver sheet 6 is provided as the viewing-angle control unit 41. In the linear louver sheet 6, a plurality of belt-shaped absorbing members 6b for absorbing visible light are embedded parallel to each other in a transparent resin sheet 6a, and the extension direction and arrangement direction of the absorbing members 6b are both orthogonal to the frontal direction. The resin sheet 6a is formed from a material that absorbs light having a wavelength of 400 nm or less, and is formed from polyethylene naphthalate (PEN), for example. Ultraviolet light that leaks from the cold cathode tube 3 can thereby be absorbed. The thickness of the linear louver sheet 6 is 0.1 mm or higher, for example.

Furthermore, in the switching element 8, two transparent plastic substrates 9a and 9b are provided spaced apart from each other and parallel to each other, and a polymer-dispersed liquid crystal layer 10 is sealed between the substrates. In the polymer-dispersed liquid crystal layer 10, liquid crystal droplets 10b are dispersed in a resin 10a. Electrodes 11a and 11b are provided to the opposing surfaces of the plastic substrates 9a and 9b. The plastic substrate 9a is bonded to the adhesive layer 7.

A transflective liquid crystal panel 12 is also provided as the display panel 42. A frame-shaped elastic resin member 13 is provided so as to touch the plastic substrate 9b of the switching element 8, and the switching element 8 is fixed to the transflective liquid crystal panel 12 and supported via the elastic resin member 13. The elastic resin member 13 is formed from a material having cushioning properties, and is formed from silicone resin, elastic rubber, or the like, for example.

In the transflective liquid crystal panel 12, two transparent substrates 14a and 14b composed of a transparent resin are arranged parallel to each other and spaced apart, and a liquid crystal layer 15 is provided between the transparent substrates. A polarizing plate 16a is provided to the outside, specifically, to the rear side of the transparent substrate 14a, and is in contact with the elastic resin member 13. A polarizing plate 16b is provided to the outside, specifically, to the front side of the transparent substrate 14b, and the plate constitutes the front-most surface of the screen of the display device 1. A pixel electrode (not shown in the drawing) is provided to the surface of the transparent substrate 14a on the side of the liquid crystal layer 15, and an opposing electrode (not shown in the drawing) is provided to the surface of the transparent substrate 14b on the side of the liquid crystal layer 15. A plurality of cells are thereby configured in a matrix in the display area of the transflective liquid crystal panel 12. A reflecting area 17 and a transmitting area 18 are established in each cell. A reflecting member 19 whereby external light that enters from the front and passes through the liquid crystal layer 15 is reflected forward is provided between the transparent substrate 14a and the liquid crystal layer 15 in the reflecting area 17.

A liquid crystal panel drive unit 22 and a switching element drive unit 23 are also provided to the drive unit 21. The liquid crystal panel drive unit 22 feeds a drive signal to the transflective liquid crystal panel 12 and causes an image to be formed in the transflective liquid crystal panel 12 on the basis of image data 24 inputted from the outside. The switching element drive unit 23 causes the switching element 8 to switch between the transparent state and the scattering state by applying a voltage to the electrodes 11a and 11b of the switching element 8. For example, when the switching element drive unit 23 is not applying a voltage to the electrodes 11a and 11b, the switching element 8 is in the transparent state. When the switching element drive unit 23 is applying a voltage to the electrodes 11a and 11b, the switching element 8 is in the scattering state. The switching element drive unit 23 at this time applies an alternating current voltage to the electrodes 11a and 11b.

When the drive frequency at which the liquid crystal panel drive unit 22 drives the transflective liquid crystal panel 12 is F1, and the frequency of the alternating current voltage applied to the switching element 8 by the switching element drive unit 23 is F2, the frequency F2 is set so as to be higher than the frequency F1 at which the transflective liquid crystal panel 12 is driven. Specifically, F2>F1. Frequency F2 is preferably twice frequency F1 or higher (F2≧2×F1), and frequency F2 is more preferably an n^{th} multiple of frequency F1 where n is an integer equal to 2 or higher. Specifically, F2=n×F1 (wherein n is an integer equal to 2 or higher) is preferred. Frequency F1 is 60 Hz, for example, and frequency F2 is 240 Hz, for example.

As shown in FIG. 5, the switching element 8 and the switching element drive unit 23 are connected to each other by a cable 25. In the display device 1, the side on which the cold cathode tube 3 is disposed in the planar light source 2 is the same side to which the cable 25 leads from the switching element 8. The width of the casing trim around the display surface is thereby reduced.

The operation of the display device according to the present embodiment configured as described above will next be described with reference to FIG. 3. The operation of the narrow-angle mode will first be described. In the narrow-angle mode, the switching element drive unit 23 does not apply a voltage to the electrodes 11a and 11b of the switching element 8. The switching element 8 is thereby placed in the transparent state. The cold cathode tube 3 of the planar light source 2 also emits light toward the optical waveguide 4. At this time, the mercury vapor inside the cold cathode tube 3 generates ultraviolet rays, these ultraviolet rays excite the phosphors, and visible light is outputted, but the ultraviolet rays generated by the mercury vapor also mix with the visible light and radiate from the cold cathode tube 3.

The light emitted from the cold cathode tube 3 enters the optical waveguide 4 from the lateral surface thereof, and radiates in a plane from this lateral surface. The main propagation direction of the light is caused by the prism sheets 5 to conform to the frontal direction. This light is then transmitted through the linear louver sheet 6, whereby the light that is propagated in directions significantly tilted from the frontal direction is absorbed by the absorbing members 6b, and only the light that is propagated in directions within a certain range of tilt angles from the frontal direction is transmitted through the resin sheet 6a. The directivity of the light is thereby increased. The ultraviolet component of this light is absorbed and blocked by the resin sheet 6a.

The high-directivity light emitted from the linear louver sheet 6 passes through the adhesive layer 7 and enters the switching element 8. Since the switching element 8 is in the transparent state, the light passes through the switching element 8 while still maintaining high directivity, enters the transflective liquid crystal panel 12, passes through the liquid crystal layer 15, and exits in the frontal direction.

After external light that is incident on the transflective liquid crystal panel 12 from the front is transmitted through the liquid crystal layer 15, the light is reflected by the reflecting member 19 in the reflecting area 17, again transmitted through the liquid crystal layer 15, and emitted towards the front.

In this state, the liquid crystal panel drive unit 22 drives the transflective liquid crystal panel 12 based on image data 24 inputted from the outside. An image can thereby be associated with the light that is emitted from the planar light source 2 and transmitted through the transmitting area 18 of the transflective liquid crystal panel 12, and the light that is incident from the outside and is reflected in the reflecting area 17. At this time, since the light emitted from the switching element 8 has high directivity, the light emitted from the transflective liquid crystal panel 12 also has high directivity, and is emitted in the frontal direction of the display device 1, but almost no light is emitted in tilted directions. An image can thereby be displayed only to an observer who is positioned in front of the display device, and eavesdropping from diagonal positions can be prevented.

The operation of the wide-angle mode will next be described. In the wide-angle mode, the switching element drive unit 23 applies an alternating current voltage having a frequency of F2 to the electrodes 11a and 11b of the switching element 8. The switching element 8 is thereby placed in the scattering state. In this state, the cold cathode tube 3 emits light, and the liquid crystal panel drive unit 22 drives the transflective liquid crystal panel 12 based on the image data 24. As described above, this frequency F2 is higher than the drive frequency F1 of the transflective liquid crystal panel 12, and is twice frequency F1 or higher, for example, or an n^{th} multiple (wherein n is an integer equal to 2 or higher) of frequency F1, for example. Frequency F1 is 60 Hz, for example, and frequency F2 is 240 Hz, for example.

In the wide-angle mode, the operation until the light emitted from the cold cathode tube 3 passes through the adhesive layer 7 is the same as in the narrow-angle mode. The light emitted from the switching element 8 in a scattered state, specifically, in a state of low directivity, is incident on the transflective liquid crystal panel 12, and is transmitted through the transmitting area 18 thereof, after which the light is outputted towards the front. At this time, the light outputted from the transflective liquid crystal panel 12 has low directivity, and is emitted in the frontal direction of the display device 1 as well as in tilted directions. An image can thereby be displayed both to an observer positioned in front of the display device and to an observer in a diagonal position.

The reasons for limiting the numerical values in the configuration conditions of the present invention will be described hereinafter.

(a) Drive Frequency F2 of Switching Element: Higher than the Drive Frequency F1 of the Liquid Crystal Panel (F2>F1)

As described above, ionic impurities are always included in the switching element 8, and the quantity thereof increases over time. The resistance of the polymer-dispersed liquid crystal layer 10 therefore decreases over time. When ionic impurities are present in the switching element 8, and a positive-negative alternating voltage that is always perfectly symmetrical is applied to the switching element, then the ionic impurities do not become unevenly distributed on the side of one of the electrodes, and the switching element exhibits the same optical response regardless of whether a positive voltage or a negative voltage is applied to the switching element. However, it is difficult to apply a positive-negative alternating voltage that is completely devoid of a direct current component to the switching element in actual practice. The ionic impurities in the switching element therefore gradually become more concentrated near the electrode on one side due to the direct-current component in the applied voltage. As the ionic impurities become unevenly distributed, the switching element exhibits a different optical response during application of a negative voltage than during application of a positive voltage, and the transmittance begins to vary. In the past, since the switching element was driven by a positive-negative alternating voltage having the same frequency as that of the liquid crystal panel, the asymmetry of the optical response described above was identified as flicker by the observer.

In contrast, when the drive frequency F2 of the switching element is made higher than the drive frequency F1 of the liquid crystal panel, asymmetry in the optical response of the switching element is less likely to be identified by the observer even when the switching element deteriorates and ionic impurities increase and become unevenly distributed. Accordingly, the drive frequency F2 of the switching element is set so as to be higher than the drive frequency F1 of the liquid crystal panel in the present invention. The frequency F2 is preferably higher than 60 Hz.

(b) Driving Frequency F2 of Switching Element: Twice the Driving Frequency F1 of the Liquid Crystal Panel or Higher (F2≧2×F1)

The transmittance of the present display device can be expressed as the product of the transmittance of the switching element and the transmittance of the display panel. As previously mentioned, the transmittance of the switching element can vary according to the positive voltage and the negative voltage. The display panel displays an image by updating the screen at a specific drive frequency. Therefore, when the drive frequency (F1) of the display panel and the drive frequency (F2) of the switching element are different, the transmittance of the display device as a whole fluctuates between the sum of the frequencies (F1+F2) and the absolute value of the difference of the frequencies (F2−F1). Since the sum of the frequencies (F1+F2) is a higher frequency than frequency F1, the fluctuation is not identified by the observer. On the other hand, the absolute value of the difference of the frequencies (F2−F1) is a low frequency, and there is a risk of flicker being noticed by the observer if the value reaches a certain level.

Therefore, when frequency F2 is twice frequency F1 or higher, the fluctuation frequency of the display (the absolute value of F2−F1) becomes F1 or higher, and flicker is no longer visible. The image can thereby be viewed without discomfort even when display fluctuation occurs. Accordingly, the drive frequency F2 of the switching element is preferably twice the drive frequency F1 of the liquid crystal panel or higher.

(c) Drive Frequency F2 of Switching Element: An n^{th} Multiple (wherein n is an Integer Equal to 2 or Higher) of the Drive Frequency F1 of the Liquid Crystal Panel (F2=n×F1)

When frequency F2 is an n^{th} multiple of frequency F1, the absolute value of the frequency (F2−F1) becomes an integer multiple of frequency F1. The frequency at which the transmittance of the image varies thereby becomes an integer multiple of the frequency at which the contents of the image change, and the discomfort experienced by the observer can be even further reduced. Accordingly, the drive frequency F2 of the switching element is preferably an n^{th} multiple (wherein n is an integer equal to 2 or higher) of the drive frequency F1 of the liquid crystal panel.

The effect of the present embodiment will next be described. According to the present embodiment, since the viewing angle of the display can be switched between a narrow angle and a wide angle, it is possible to both prevent eavesdropping in the narrow-angle mode, and to allow multiple users to view an image all at once in the wide-angle mode.

Flicker can be prevented in the present embodiment according to the principles described above.

Furthermore, in the present embodiment, since the plastic substrates 9a and 9b are the substrates of the switching element 8, and the transparent substrates 14a and 14b of the transflective liquid crystal panel 12 are formed from resin, the thickness and weight of the display device 1 can be reduced, and the mechanical durability thereof can be increased.

However, forming the substrates of the switching element 8 from plastic creates several problems. Measures are therefore taken in the present embodiment to overcome these problems. The problems caused by using plastic substrates for the substrates of the switching element 8, and the measures taken to overcome those problems will be described hereinafter.

Liquid crystal is generally degraded by ultraviolet radiation. However, in a common liquid crystal panel used for image display, a polarizing plate is affixed to both sides of a transparent substrate, and this polarizing plate functions as an effective ultraviolet-blocking member. The liquid crystal is therefore not exposed to an environment of harsh ultraviolet radiation. In the present embodiment, however, scattering-type liquid crystal is disposed between the light source and the display panel. Therefore, a portion of the ultraviolet light for exciting the phosphors in the cold cathode tube is directly incident on the scattering-type liquid crystal member, causing ultraviolet degradation of the liquid crystal. Particularly in the present embodiment, the polymer-dispersed liquid crystal layer included in the switching element is scattering-type liquid crystal, and is therefore manufactured by ultraviolet exposure. A substrate is therefore used in the plastic substrate of the switching element that is capable of transmitting ultraviolet rays. The liquid crystal droplets in the polymer-dispersed liquid crystal layer are consequently degraded by ultraviolet rays if a member for absorbing ultraviolet rays is not disposed between the cold cathode tube and the switching element. The same problem occurs even when guest-host liquid crystal is used in the switching element. In this case, degradation of the dichroic dye member occurs in addition to degradation of the liquid crystal member.

To overcome this problem, the resin sheet 6a of the linear louver sheet 6 in the present embodiment is formed from a material that absorbs ultraviolet rays. The ultraviolet rays emitted from the cold cathode tube 3 are therefore blocked by the linear louver sheet 6. The switching element 8 is thereby prevented from being exposed to ultraviolet rays, and the liquid crystal droplets 10b of the switching element 8 are not degraded by the ultraviolet rays.

Plastic also has high moisture permeability compared to glass. It is therefore impossible to ensure the long-term operation of the liquid crystal in the interior when the substrate of the switching element is formed from plastic. The inside surface of the plastic substrate is usually coated with a silicon oxide film or the like for increased moisture-proofing when a plastic substrate is used in the liquid crystal panel. However, it becomes necessary in this case to form two or more layers that include the silicon oxide film and the transparent electrode layer on the inside surface of the plastic substrate. The reliability ensured by a multilayer structure thus necessitates an expensive plastic substrate.

Therefore, in the present embodiment, the entire surface of the plastic substrate 9a of the switching element 8 is bonded to the linear louver sheet 6 via the adhesive layer 7. The effective thickness of the plastic substrate on the back surface side of the switching element 8 thus increases, and moisture can be prevented from penetrating from the back surface side. It is thereby sufficient to apply a moisture-blocking coating only to the plastic substrate on the front surface side, and it is no longer necessary to apply a moisture-blocking coating to the plastic substrate on the back surface side. Reliability can therefore be ensured while keeping the cost low. Particularly in the present embodiment, since the thickness of the linear louver sheet 6 is 0.1 mm or higher, adequate moisture-blocking ability can be obtained. As a result, degradation of the switching element over time can be suppressed, and the reliability of the display device can be enhanced.

Another problem is that the scattering-type liquid crystal is susceptible to mechanical impact. As mentioned above, known scattering-type liquid crystals include polymer-dispersed liquid crystal, polymer network liquid crystal, capsule-type liquid crystal, and the like. The structure shared by these types of liquid crystal is a structure having a liquid crystal phase and a resin phase. Scattering/transparent switching is thereby achieved by nonalignment/alignment of the refractive indexes of the liquid crystal phase and the resin phase. The resin phase among these phases has a fixed structure, and is therefore particularly susceptible to mechanical impact and cannot be restored once it is broken. The scattering-type liquid crystal usually has a thickness of about several microns or less. This extremely thin solid resin layer must be kept mechanically stable. However, mechanical problems occur when the resin layer is disposed between plastic substrates. The plastic substrates easily undergo twisting, bending, and other deformation from external force and the like. The assembly is therefore considerably more vulnerable compared to a case in which the scattering-type liquid crystal member is disposed between glass substrates. Although there is no fixed structure such as a resin phase in the interior in the case of a guest-host liquid crystal member, uneven display still occurs in conditions where the plastic substrates are easily deformed. Specifically, the problem of uneven display arises when the plastic substrates are flexed, and thick portions and thin portions occur in the guest-host liquid crystal member. Since the display device with a switchable viewing angle is often used in mobile or portable terminal devices, the possibility of impact from dropping or during use must be considered, and this vulnerability to mechanical impact becomes a problem.

Therefore, in the present embodiment, the switching element 8 is fixed to the transflective liquid crystal panel 12 via the elastic resin member 13. The switching element 8 can thereby be protected from mechanical stress.

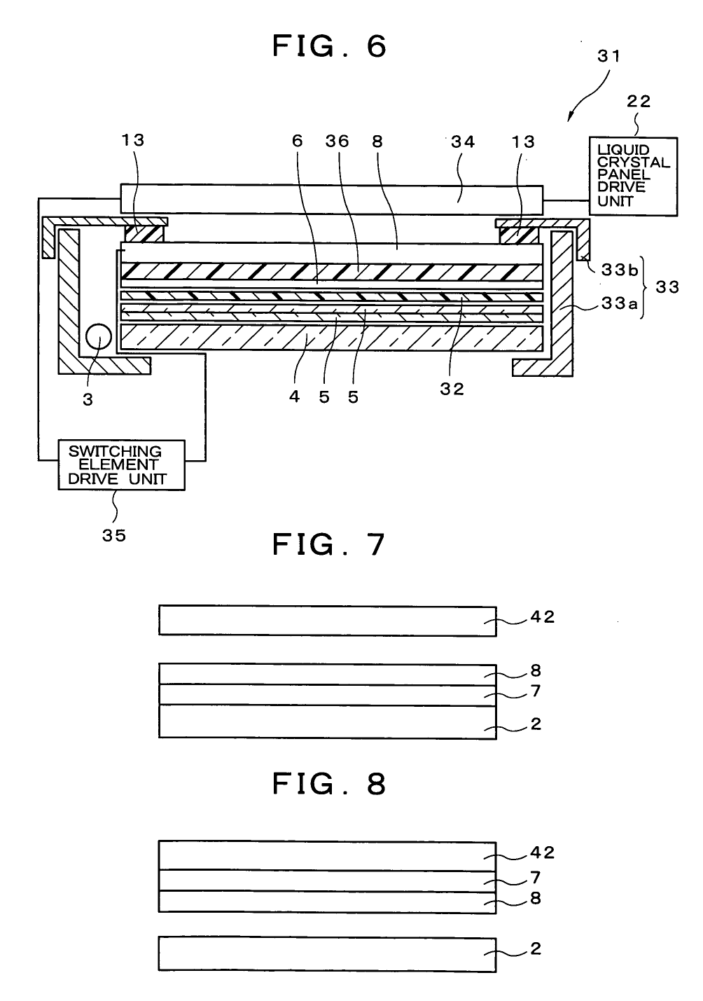

A second embodiment of the present invention will next be described. FIG. 6 is a sectional view of the display device according to the present embodiment. As shown in FIG. 6, a diffusing plate 32 is disposed between the prism sheets 5 and the linear louver sheet 6 in the display device 31 according to the present embodiment. The diffusing plate 32 is formed from a resin material (polyethylene naphthalate (PEN), for example). The plate transmits visible light and absorbs light having a wavelength of 400 nm or less. Ultraviolet light leaking from the cold cathode tube 3 can thereby be absorbed. In the present embodiment, the resin sheet 6a of the linear louver sheet 6 may be formed from a material that absorbs ultraviolet rays in the same manner as in the previously described first embodiment, or may be formed from a material that does not absorb ultraviolet rays.

A frame 33 for housing the planar light source 2, diffusing plate 32, linear louver sheet 6, switching element 8, and elastic resin member 13 may also be provided to the display device 31. The frame 33 is formed in a frame shape by fitting a front frame 33b into a rear frame 33a. The frame 33 covers the periphery of the back surface of the planar light source 2 and the lateral surfaces of the planar light source 2, diffusing plate 32, linear louver sheet 6, switching element 8, and elastic resin member 13. The front frame 33b covers the lateral surfaces and the periphery of the front surfaces of the switching element 8 and elastic resin member 13. The front surface of the switching element 8 is bonded and fixed to the front frame 33b via the elastic resin member 13.

Furthermore, an elastic resin member 36 is provided to the display device 31 instead of the adhesive layer 7 in the previously described first embodiment. Specifically, the elastic resin member 36 is disposed between the linear louver sheet 6 and the switching element 8. The switching element 8 is thereby fixed to the linear louver sheet 6 via the elastic resin member 36.

A transmissive liquid crystal panel 34 is also provided to the display device 31 instead of the transflective liquid crystal panel 12 in the previously described first embodiment.

A switching element drive unit 35 is also provided to the display device 31 instead of the switching element drive unit 23 in the previously described first embodiment. The switching element drive unit 35 receives a drive synchronization signal from the transmissive liquid crystal panel 34, creates a signal having a frequency four times that of the drive synchronization signal, and supplies a drive voltage to the switching element 8 based on this signal. Therefore, if the transmissive liquid crystal panel 34 is driven at a frequency of 60 Hz, for example, then the switching element 8 is synchronized with the transmissive liquid crystal panel 34 and driven at a frequency of 240 Hz. Aspects of the configuration in the present embodiment other than those described above are the same as in the previously described first embodiment.

The operation and effects of the present embodiment will next be described. A reset period is sometimes set according to the display panel. In such cases, even when the drive frequency F2 of the switching element is a multiple of the drive frequency F1 of the display panel, the transmittance of the display device varies between frames in which a positive potential is applied and frames in which a negative potential is applied if the drive timing of the switching element and display panel are not synchronized. In contrast, by synchronizing the drive timing of the switching element with the drive timing of the display panel in the present embodiment, the transmittance can be prevented from varying between frames in which a positive potential is applied and frames in which a negative potential is applied. The occurrence of flicker can thereby be more reliably prevented.

In the present embodiment, the switching element 8 is fixed to the front frame 33b of the frame 33 via the elastic resin member 13, and is fixed to the linear louver sheet 6 via the elastic resin member 36. Specifically, the switching element 8 is supported by the elastic resin members 13 and 36. The switching element 8 can thereby be protected from mechanical stress, and the moisture-blocking properties of the back surface side of the switching element can also be enhanced. As a result, the reliability of the display device 31 can be enhanced without increasing the number of components thereof. Effects and operational aspects in the present embodiment other than those described above are the same as in the previously described first embodiment.

A third embodiment of the present invention will next be described. FIG. 7 is a side view of the display device according to the present embodiment. In FIG. 7, the drive units are omitted in order to simplify the drawing. The same applies to FIGS. 8 through 15 described hereinafter. As shown in FIG. 7, the viewing-angle control unit 41 (see FIG. 3) is not provided in the present embodiment, and the planar light source 2 is bonded to the plastic substrate (not shown in the drawing) on the back surface side of the switching element 8 via the adhesive layer 7. The effective thickness of the plastic substrate on the back surface side of the switching element 8 thus increases, and moisture can be prevented from penetrating from the back surface side. The display panel 42 is also provided to this display device. The display panel 42 may be the same as the transflective liquid crystal panel 12 in the previously described first embodiment, or may be the same as the transmissive liquid crystal panel 34 in the previously described second embodiment, or may be a transmissive-type display panel other than a liquid crystal panel. Effects and aspects of the structure and operation in the present embodiment other than those described above are the same as in the previously described first embodiment.

A fourth embodiment of the present invention will next be described. FIG. 8 is a side view of the display device according to the present embodiment. As shown in FIG. 8, the adhesive layer 7 in the present embodiment is disposed on the front surface side instead of on the back surface side of the switching element 8. The entire surface of the plastic substrate on the front surface side of the switching element 8 is thereby bonded to the back surface of the display panel 42 via the adhesive layer 7. The effective thickness of the plastic substrate on the front surface side of the switching element 8 thus increases, and moisture can be prevented from penetrating from the front surface side. Effects and aspects of the structure and operation in the present embodiment other than those described above are the same as in the previously described first embodiment.

In the present embodiment, when the display panel 42 is a liquid crystal panel in which a polarizing plate is provided to the front surface side and back surface side thereof, and the switching element 8 is bonded to the polarizing plate on the back surface side via the adhesive layer 7, the thickness of the polarizing plate on the back surface side is preferably 0.1 mm or greater. Moisture is thereby adequately prevented from penetrating from the front surface side of the switching element 8.

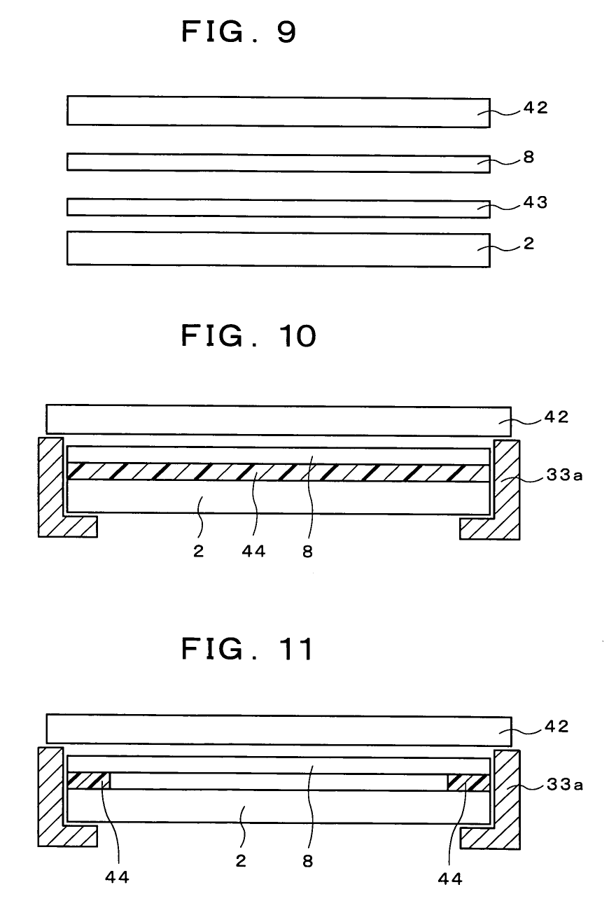

A fifth embodiment of the present invention will next be described. FIG. 9 is a side view of the display device according to the present embodiment. As shown in FIG. 9, the viewing-angle control unit 41 (see FIG. 3) is not provided in the present embodiment, and an ultraviolet-absorbent sheet 43 is instead provided between the cold cathode tube 3 and the switching element 8. The ultraviolet-absorbent sheet 43 is formed from polyethylene naphthalate (PEN), for example. Ultraviolet rays emitted from the cold cathode tube of the planar light source 2 can thus be blocked by the ultraviolet-absorbent sheet 43, and the switching element 8 can be protected from ultraviolet rays. As a result, degradation of the switching element 8 by ultraviolet rays can be prevented, and it becomes possible to ensure the reliability of the display device. Effects and aspects of the structure and operation in the present embodiment other than those described above are the same as in the previously described first embodiment. The ultraviolet-absorbent sheet 43 may also be bonded to the switching element 8. Ultraviolet-blocking capability as well as moisture-blocking capability can thereby be imparted to the ultraviolet-absorbent sheet 43.

A sixth embodiment of the present invention will next be described. FIG. 10 is a sectional view of the display device according to the present embodiment. As shown in FIG. 10, the present embodiment differs from the previously described second embodiment in that the front fame is omitted, an elastic resin member 44 is disposed over the entire surface on the back surface side of the switching element 8, and the switching element 8 is fixed to the planar light source 2 via this elastic resin member 44. Since the elastic resin member 44 thus absorbs mechanical impacts, no large forces are exerted on the switching element 8, and the resin 10a (see FIG. 4) in the switching element 8 can be prevented from breaking. Expansion and contraction that occur between the switching element 8 and the rear frame 33a, and expansion and contraction that occur between the switching element 8 and the planar light source 2 in conjunction with temperature changes can also be absorbed by the elastic resin member 13. Therefore, the switching element does not undergo thermal stress even when the temperature changes, and the switching element can be prevented from breaking. Effects and aspects of the structure and operation in the present embodiment other than those described above are the same as in the previously described second embodiment.

A seventh embodiment of the present invention will next be described. FIG. 11 is a sectional view of the display device according to the present embodiment. As shown in FIG. 11, the present embodiment differs from the previously described sixth embodiment in that the elastic resin member 44 is provided only to the peripheral portion of the back surface of the switching element 8. Effects and aspects of the structure and operation in the present embodiment other than those described above are the same as in the previously described sixth embodiment.

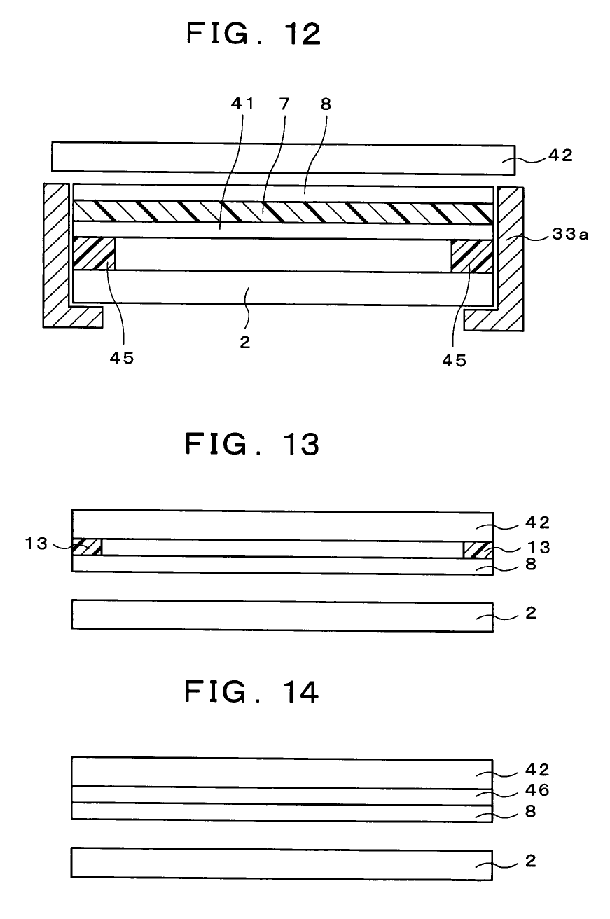

An eighth embodiment of the present invention will next be described. FIG. 12 is a sectional view of the display device according to the present embodiment. As shown in FIG. 12, in the present embodiment, the viewing-angle control unit 41 and the switching element 8 are affixed to each other by the adhesive layer 7, and the resulting joint is fixed to the planar light source 2 by an elastic resin member 45. The joint between the viewing-angle control unit 41 and the switching element 8 is thereby supported by the elastic resin member 45. As a result, a display device can be obtained that has excellent moisture resistance and resistance to mechanical impact and thermal expansion.

A ninth embodiment of the present invention will next be described. FIG. 13 is a sectional view of the display device according to the present embodiment. As shown in FIG. 13, in the present embodiment, the switching element 8 is fixed to the display panel 42 by the elastic resin member 13. The elastic resin member 13 is provided in a frame shape on the periphery of the back surface side of the display panel 42. Effects and aspects of the structure and operation in the present embodiment other than those described above are the same as in the previously described first embodiment.

A tenth embodiment of the present invention will next be described. FIG. 14 is a side view of the display device according to the present embodiment. As shown in FIG. 14, in the present embodiment, the switching element 8 is fixed to the display panel 42 by an elastic resin member 46. The elastic resin member 46 is provided on the entire surface of the back surface side of the display panel 42. Effects and aspects of the structure and operation in the present embodiment other than those described above are the same as in the previously described first embodiment.

The optical waveguide may be endowed with ultraviolet absorption capability in the embodiments described above. Examples were described in the aforementioned embodiments in which a side-lighting-type light source is used as the planar light source, but the present invention is not limited by this configuration, and a bottom-lighting light source may also be used. A bottom-lighting light source is composed of a plurality of light source elements and a diffusing sheet disposed above the light source elements for creating uniform luminance. When a bottom-lighting light source is used, the diffusing sheet may be endowed with ultraviolet absorption capability. In any case, by providing ultraviolet absorption capability to a portion of the planar light source, a separate ultraviolet absorption layer can be dispensed with, and degradation of the switching element can be prevented without increasing the number of components.

It is also possible to provide ultraviolet absorption capability to a prism sheet for improving the directivity of the planar light source. This capability can be created through the selection of constituent materials or by mixing an ultraviolet-absorbent substance into the constituent materials. Reliability can thereby be ensured without further increasing the number of components.

Examples were also described in the aforementioned embodiments in which a scattering-type liquid crystal element is used as the switching element that is in a transparent state when a voltage is not being applied, and is in a scattering state when a voltage is being applied. However, the present invention is not limited by this configuration, and a scattering-type liquid crystal element may be used that is in the scattering state when a voltage is not being applied, and is in the transparent state when a voltage is being applied. A guest-host liquid crystal element that is provided with dichroic dye molecules having a slender shape may also be used as the switching element.

Furthermore, the thickness of the adhesive layer or elastic resin member is preferably 10 microns or greater in the previously described embodiments. Fringe lines caused by in-plane optical interference can thereby be made less noticeable. For example, in the eighth embodiment shown in FIG. 12, by setting the thickness of the elastic resin member 45 to 10 microns or greater, the occurrence of fringe lines due to optical interference between the front surface of the planar light source 2 and the back surface of the viewing-angle control unit 41 can be suppressed. The same effects can be obtained by giving the adhesive layer 7 a thickness of 10 microns or greater. For example, in FIG. 12, by giving the adhesive layer 7 a thickness of 10 microns or greater, it is possible to suppress optical interference between the front surface of the viewing-angle control unit 41 and the back surface of the switching element 8.

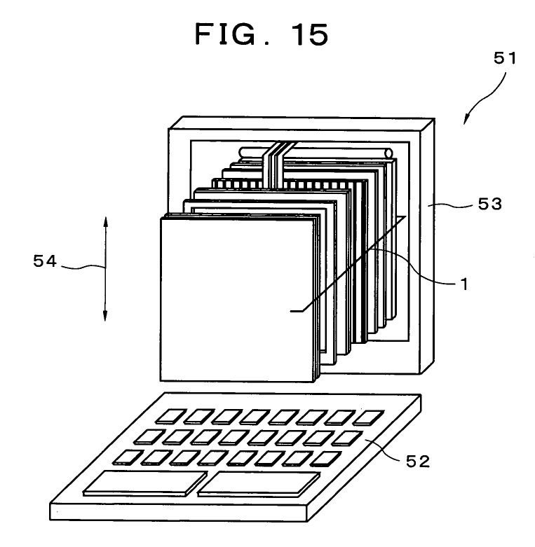

An eleventh embodiment of the present invention will next be described. The present embodiment is an embodiment of the terminal device according to the present invention. FIG. 15 is a perspective view of the terminal device according to the present embodiment. As shown in FIG. 15, the terminal device according to the present embodiment is a notebook-type personal computer (notebook PC) 51. An operating unit 52 and a display unit 53 that is rotatably connected to the edge of this operating unit 52 are provided in this notebook PC 51, and the display device 1 with a switchable viewing angle is built into the display unit 53. This display device 1 is the same as the display device 1 (see FIGS. 3 through 5) according to the previously described first embodiment. The extension direction of the absorbing members 6b (see FIG. 4) of the linear louver sheet 6 in the display device 1 substantially coincides with the direction 54 perpendicular to the screen of the notebook PC 51. The operation and effects of the present embodiment are the same as in the previously described first embodiment.

When moiré caused by interference between the linear louver sheet and the display panel is a concern, the extension direction of the absorbing members 6b may be tilted at an angle of 10 degrees or less from the direction 54 perpendicular to the screen. Moiré can thereby be reduced. Moiré may also be eliminated by furthermore providing a diffusing sheet between the linear louver sheet 6 and the switching element 8. The display device according to any of the previously described second through tenth embodiments may also be incorporated into the display unit 53 of the notebook PC 51. Outdoor use is common particularly when the terminal device of the present embodiment is a mobile/portable-type terminal device, and a device having excellent reliability is desired. A terminal device that meets the aforementioned requirements can be obtained by applying the display device according to the abovementioned first through tenth embodiments to this type of terminal device.

An example was described in the present embodiment in which the terminal device is a notebook-type personal computer, but the present invention is not limited by this configuration, and may also be applied to a mobile telephone, PDA, or the like.

What is claimed is:

1. A display device with a switchable viewing angle, comprising:
a switching element that is capable of switching between scattering and directly transmitting incident light;
a display panel which displays an image by transmitting the light that is emitted from the switching element; and
a drive unit for switching the switching element to the transmitting state or to the scattering state by switching on and off the application of an alternating current voltage to said switching element;
wherein the frequency of said alternating current voltage applied by said drive unit to said switching element is higher than the drive frequency of said display panel.

2. The display device with a switchable viewing angle according to claim 1, wherein
the frequency of said alternating current voltage being higher than 60 Hz.

3. The display device with a switchable viewing angle according to claim 1, wherein
the frequency of said alternating current voltage being twice the drive frequency of said display panel or higher.

4. The display device with a switchable viewing angle according to claim 3, wherein
the frequency of said alternating current voltage being an n^{th} multiple (wherein n is an integer equal to 2 or higher) of the drive frequency of said display panel.

5. The display device with a switchable viewing angle according to claim 1, wherein
said drive unit synchronizing the drive timing of said switching element with the drive timing of said display panel.

6. The display device with a switchable viewing angle according to claim 1, said switching element comprising:
two substrates composed of transparent plastic; and
a liquid crystal layer disposed between the substrates.

7. The display device with a switchable viewing angle according to claim 6, comprising:
one of said substrates being bonded to said display panel.

8. The display device with a switchable viewing angle according to claim 6, comprising:
a light source for emitting light to said switching element; and
one of said substrates being bonded to said light source.

9. The display device with a switchable viewing angle according to claim 6, comprising:
a viewing-angle control unit for increasing the directivity of light that is incident on said switching element; and
one of said substrates being bonded to said viewing-angle control unit.

10. The display device with a switchable viewing angle according to claim 6, comprising:
a light source for emitting light to said switching element; and
ultraviolet rays being absorbed in the light path from the light source to said switching element.

11. The display device with a switchable viewing angle according to claim 10, comprising:
an ultraviolet-absorbing sheet disposed so as to be interposed in said light path.

12. The display device with a switchable viewing angle according to claim 11, comprising:
one of said substrates being bonded to said ultraviolet-absorbing sheet.

13. The display device with a switchable viewing angle according to claim 10, wherein
said light source having a cold cathode tube, and an optical waveguide for emitting the light incident from the cold cathode tube in a plane towards said switching element; and
said optical waveguide being formed from a material that absorbs ultraviolet rays.

14. The display device with a switchable viewing angle according to claim 10, wherein
said light source having a cold cathode tube, an optical waveguide for emitting the light incident from the cold cathode tube in a plane, and an optical element for emitting the light incident from the optical waveguide towards said switching element; and
said optical element being formed from a material that absorbs ultraviolet rays.

15. The display device with a switchable viewing angle according to claim 10, comprising:
a viewing-angle control unit for increasing the directivity of light that is incident on said switching element, the viewing-angle control unit being formed from a material that absorbs ultraviolet rays.

16. The display device with a switchable viewing angle according to claim 6, comprising:
an elastic resin member for supporting said switching element.

17. The display device with a switchable viewing angle according to claim 16, wherein
said switching element being fixed to said display panel via said elastic resin member.

18. The display device with a switchable viewing angle according to claim 16, comprising:
a viewing-angle control unit for increasing the directivity of light that is incident on said switching element, said switching element being fixed to said viewing-angle control unit via said elastic resin member.

19. The display device with a switchable viewing angle according to claim 16, comprising:
a viewing-angle control unit for increasing the directivity of light that is incident on said switching element, said switching element and said viewing-angle control unit being joined to each other, and the resulting joint being supported by said elastic resin member.

20. The display device with a switchable viewing angle according to claim 16, comprising:
a light source for emitting light to said switching element, said switching element being fixed to said light source via said elastic resin member.

21. The display device with a switchable viewing angle according to claim 16, comprising;
a frame for housing said switching element, said switching element being fixed to said frame via said elastic resin member.

22. The display device with a switchable viewing angle according to claim 16, wherein
the thickness of said elastic resin member being 10 microns or greater.

23. A terminal device comprising the display device with a switchable viewing angle according to claim 1.
